(19) United States
(12) Patent Application Publication
(10) Pub. No.: US 2022/0263381 A1
(43) Pub. Date: Aug. 18, 2022

(54) ROTARY ELECTRIC MACHINE

(71) Applicant: KYB CORPORATION, Tokyo (JP)

(72) Inventors: Shun Matsuda, Kanagawa (JP); Haruki Tomita, Kanagawa (JP); Hirotaka Tsukada, Kanagawa (JP)

(21) Appl. No.: 17/630,722

(22) PCT Filed: Mar. 26, 2020
(86) PCT No.: PCT/JP2020/013870

§ 371 Date: Jan. 27, 2022

(30) Foreign Application Priority Data
Aug. 5, 2019 (JP) 2019-143617

(51) Int. Cl. H02K 5/22; H02K 9/22

(52) U.S. Cl. CPC H02K 5/225; H02K 9/227

(57) ABSTRACT

In the rotary electric machine, the circuit board is divided into a first substrate portion fixed to the heat sink and a second substrate portion to which one end of first to third terminals are soldered, in the first direction. Here, the heat sink is formed with first and second recesses and a step portion separated upward from the second substrate portion, and displacement of the second substrate portion in the plate thickness direction is allowed. Thus, in the event that the first to third terminals are displaced vertically with respect to the circuit board when the environmental temperature of the rotary electric machine 10 changes, since the second substrate portion is displaced in the vertical direction following the first to third terminals, the stress generated in the soldered portion between the first to third terminals and the second substrate portion can be relaxed for enhanced reliability.

### TECHNICAL FIELD

The present invention relates to a rotary electric machine.

### BACKGROUND ART

In the drive device (rotary electric machine) described in Patent Document 1 below, a frame member (heat sink) is attached to the opening of the motor case of the motor. Further, a circuit board is arranged on the side of the frame member opposite to the motor, and the circuit board is fixed to the frame member. Further, a cover member is provided on the side of the circuit board opposite to the frame member, and the circuit board is covered with the cover member. A connector terminal (terminal) is integrally formed on this cover member, and the connector terminal is soldered to a circuit board.

### CITATION LIST

### Patent Document

[Patent Document 1]
Japanese Patent No. 6160576.

### SUMMARY OF INVENTION

### Technical Problem

However, in the above-mentioned drive device, there is room for improvement in the following points. That is, in the above-mentioned drive device, as described above, the circuit board is fixed to the frame member, and the connector terminal soldered to the circuit board is integrally formed on the circuit board. Therefore, for example, when the environmental temperature of the drive device changes, the connector terminals may act to be displaced relative to the circuit board in the plate thickness direction due to thermal deformation of the cover member, the circuit board, or the like. In this case, for example, stress may be generated in the soldered portion of the connector terminal to the circuit board. At this time, if a crack or the like occurs in the soldered portion, a connection failure may occur between the connector terminal and the circuit board, and the reliability of the drive device may decrease.

It is an object of the present invention to provide a rotary electric machine capable of improving reliability in consideration of the above facts.

### Solution of Problem

At least one embodiment of the present invention is a rotary electric machine comprising: a motor portion with a bottomed cylindrical housing with one end closed in the axial direction; a heat sink that closes an opening of the housing; a connector assembly configured to include a mold portion fixed to the heat sink and a terminal integrally formed with the mold portion; a substrate that is divided into a first substrate portion fixed to the heat sink and a second substrate portion to which the terminal is soldered, wherein the entire substrate overlaps the heat sink when viewed from the axial direction of the motor portion; a displacement allowing portion that constitutes a portion of the heat sink facing the second substrate portion, is arranged apart from the second substrate portion, and allows displacement of the second substrate portion in the plate thickness direction.

At least one embodiment of the present invention is a rotary electric machine, characterized in that the terminal extends along the plate thickness direction of the substrate and includes a bent portion bent in a direction intersecting the extending direction.

At least one embodiment of the present invention is a rotary electric machine, characterized in that the first substrate portion is provided with a connection terminal for being press-fitted and fixed to the bus bar of the motor portion.

At least one embodiment of the present invention is a rotary electric machine characterized in that: an insertion portion through which one end of the terminal is inserted is formed in the displacement allowing portion; one end of the terminal protrudes to the opposite side of the displacement allowing portion of the substrate; the solder connection portion between the terminal and the substrate is configured to be visible from the gap between the displacement allowing portion and the substrate.

### BRIEF DESCRIPTION OF DRAWINGS

FIG. 1 is a perspective view which shows the rotary electric machine according to this embodiment in a partially disassembled state.

FIG. 2 is a vertical sectional view seen from one side of the second direction which shows the rotary electric machine according to this embodiment.

FIG. 3 is a side view seen from one side of the first direction which shows the connection state of a bus-bar and a connector shown in FIG. 2.

FIG. 4A is a bottom view of the ECU unit shown in FIG. 1 as viewed from below, and FIG. 4B is a side view showing the ECU unit of FIG. 4A.

FIG. 5 is an exploded perspective view of the ECU unit shown in FIG. 4 disassembled and viewed from below.

FIG. 6 is an exploded perspective view of the ECU unit shown in FIG. 4 disassembled and viewed from above.

FIG. 7 is a bottom view of the heat-sink shown in FIG. 5 as viewed from below.

FIG. 8 is a plan view seen from the upper side which shows the positional relationship between the FET of the circuit board and the connector assembly shown in FIG. 6.

FIG. 9 is a bottom view seen from the lower side which shows the connector shown in FIG. 5 in an enlarged manner.

FIG. 10 is an exploded perspective view of the connector shown in FIG. 5 disassembled and viewed from below.

FIG. 11 is sectional view (11-11 line sectional view of FIG. 4) which shows the holding state of the connection terminal in the terminal holder in the connector shown in FIG. 4.

FIG. 12 is a perspective sectional view showing a state in which the positioning pin of the terminal holder in the connector shown in FIG. 4 is fitted in the positioning hole on the first heat sink side of the heat sink.

FIG. 13 is a bottom view of the connector assembly shown in FIG. 5 as viewed from below.

### DESCRIPTION OF EMBODIMENTS

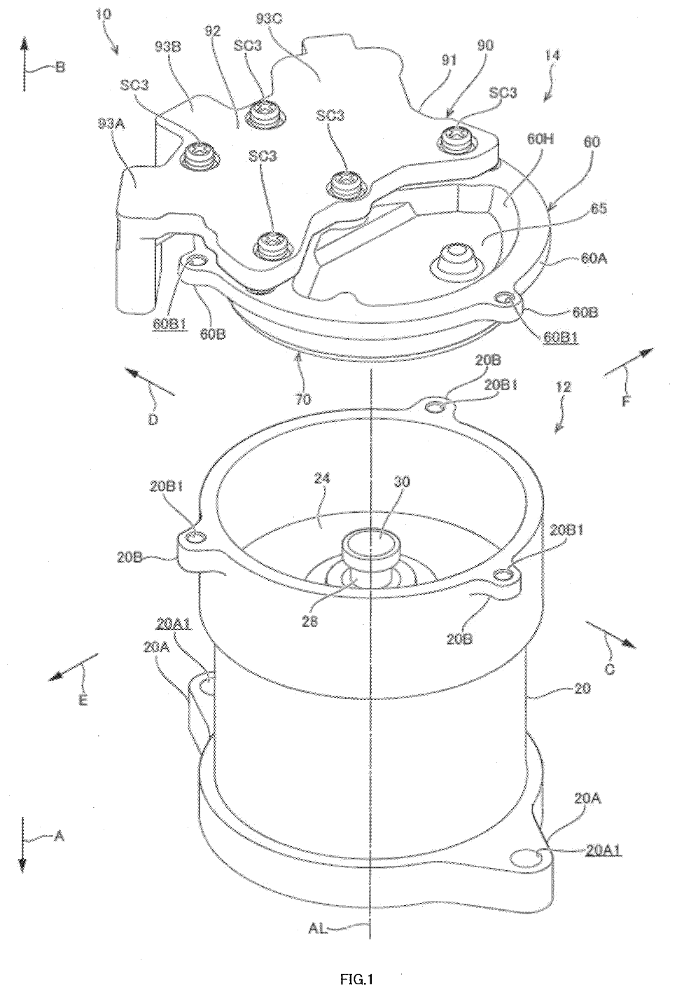

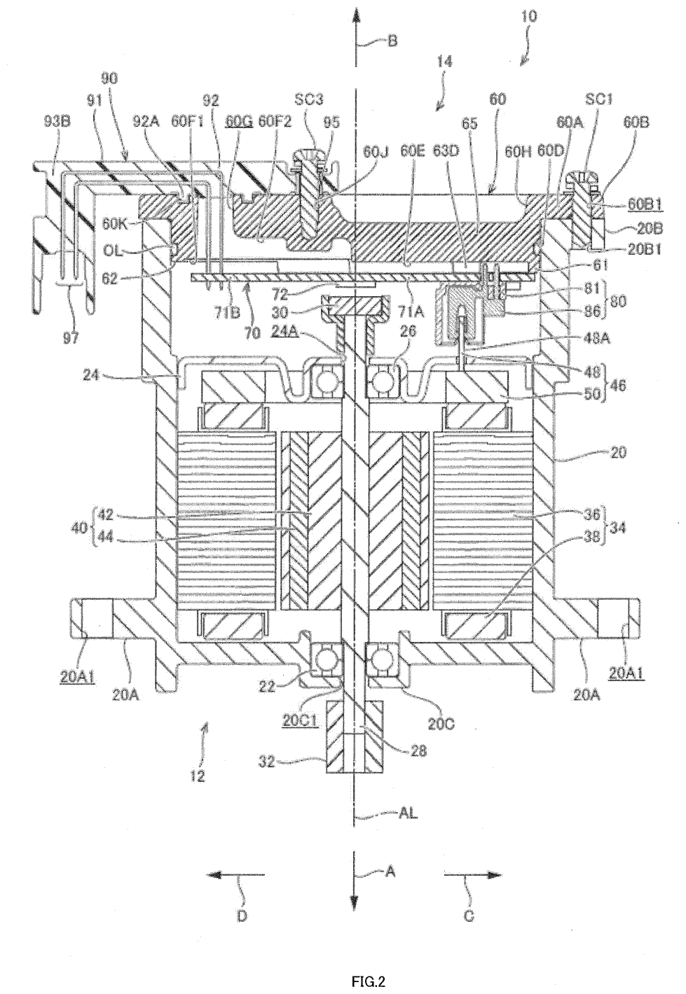

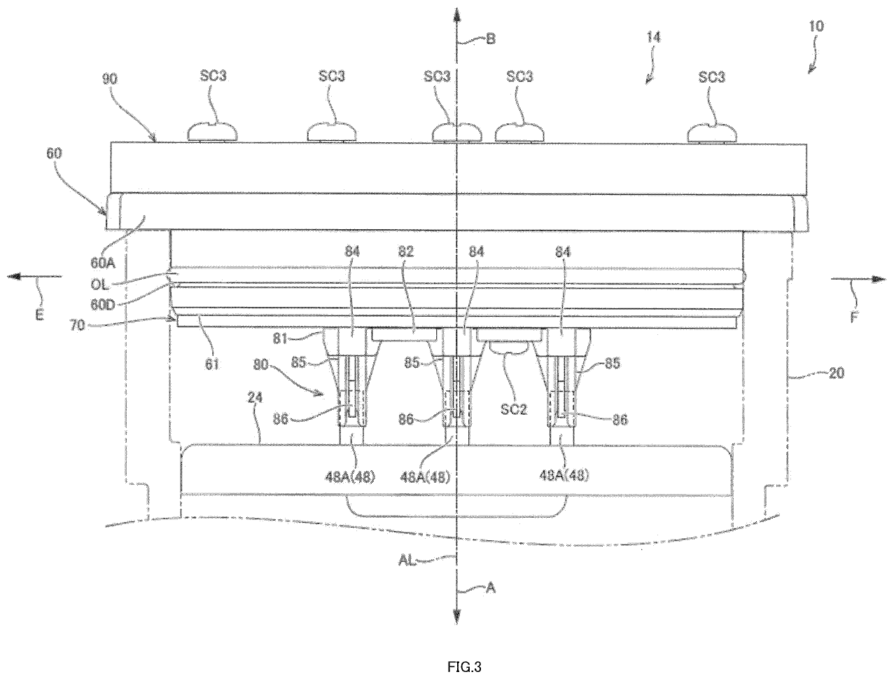

Hereinafter, the rotary electric machine 10 according to the present embodiment will be described with reference to the drawings. The rotary electric machine 10 is configured as a rotary electric machine applied to a steering device of a vehicle (automobile). As shown in FIGS. 1 and 2, the rotary electric machine 10 is formed in a roughly columnar shape as a whole. Further, the rotary electric machine 10 comprises a motor portion 12 and an ECU unit 14 for controlling the rotation of the motor portion 12. Hereinafter, each configuration of the rotary electric machine 10 will be described.

In the following description, one side of the rotary electric machine 10 in the axial direction (arrow A direction side of FIGS. 1 and 2) is the lower side of the rotary electric machine 10, and the other side of the rotary electric machine 10 in the axial direction (arrow B direction side of FIGS. 1 and 2) is the upper side of the rotary electric machine 10. In the following description, when the vertical direction is used, the upper-lower direction of the rotary electric machine 10 is indicated unless otherwise specified.

Further, in the following description, in a plan view seen from above, the direction orthogonal to the vertical direction is defined as the first direction (cf. arrows C and D in FIGS. 1 and 2), and the direction orthogonal to the first direction is defined as the second direction (cf. arrow E and arrow F in FIG. 1). The first direction corresponds to the “orthogonal direction” of the present invention.

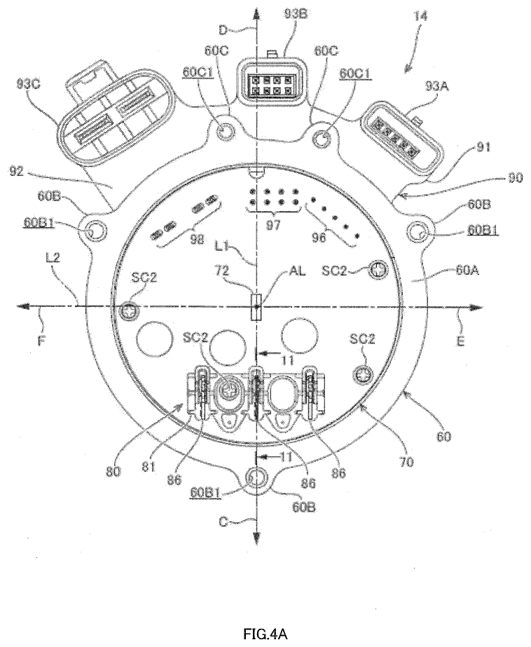

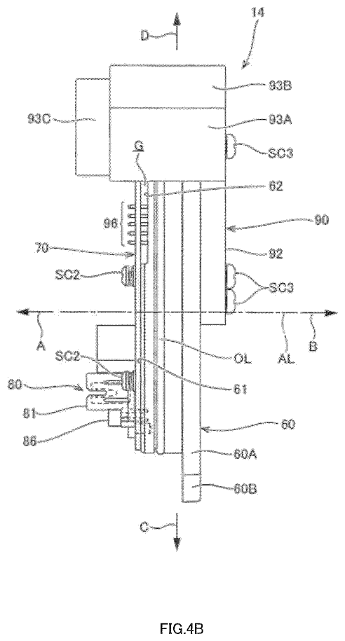

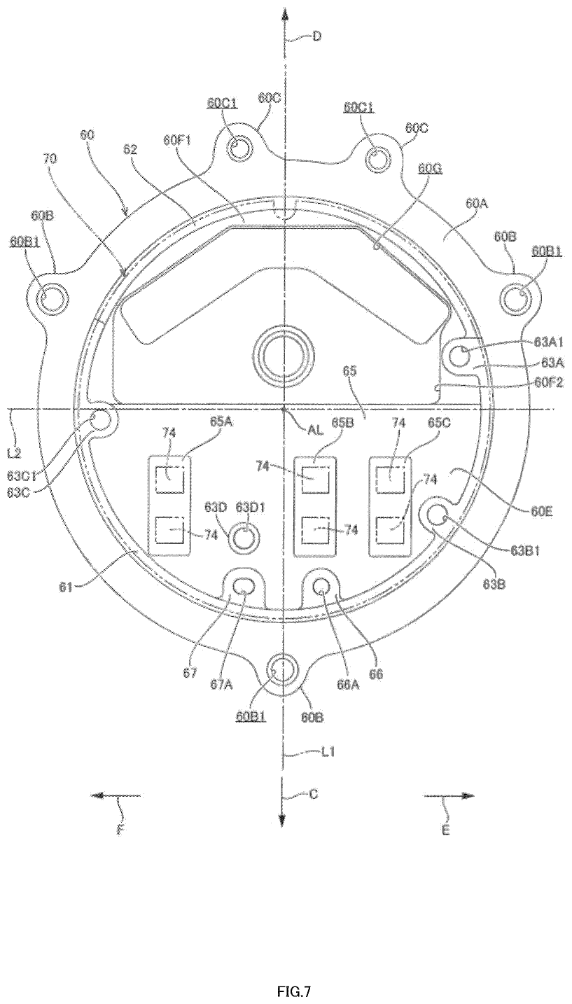

In addition, in a plan view, the overhead line that passes through the axis AL of the rotary electric machine 10 and extends in the first direction is defined as the first reference line L1 (cf. FIGS. 4 and 7), and the overhead line that passes through the axis AL of the rotary electric machine 10 and extends in the second direction is defined as the second reference line L2 (cf. FIGS. 4 and 7).

(The Motor Portion 12)

As shown in FIGS. 1 and 2, the motor portion 12 is configured as a three-phase alternating current brushless motor. The motor portion 12 comprises a housing 20, a plate holder 24 housed in the housing 20, a rotating shaft 28, a stator 34, a rotor 40, and a bus-bar unit 46.

<The Housing 20>

The housing 20 is formed in a roughly bottomed cylindrical shape that is open to the upper side, and constitutes the outer shell of the rotary electric machine 10. A pair of mounting pieces 20A are integrally formed on the outer peripheral portion of the lower end portion of the housing 20. The pair of mounting pieces 20A are arranged with the axial direction of the housing 20 as the plate thickness direction, and project from the housing 20 to one side in the first direction (arrow C direction side of FIGS. 1 and 2) and the other side in the first direction (arrow D direction side of FIGS. 1 and 2). A mounting hole 20A1 is formed through the mounting piece 20A. A fastening member such as a bolt (not shown) is inserted into the mounting hole 20A1, and the housing 20 (that is, the rotary electric machine 10) is fixed to the steering device by the fastening member.

A plurality of (three locations in the present embodiment) fixing portions 20B extending outward in the radial direction are formed on the outer peripheral portion of the opening end portion of the housing 20. One fixing portion 20B protrudes from the housing 20 to one side in the first direction, and three fixing portions 20B are arranged at equal intervals in the circumferential direction of the housing 20. A screw portion 20B1 for fixing the heat-sink 60, which will be described later, is formed through the fixing portion 20B, and a female screw is formed on the inner peripheral surface of the screw portion 20B1.

Further, in the central portion of the bottom wall of the housing 20, a bottomed cylindrical fixed cylinder portion 20C that is bulged downward is integrally formed, and a first bearing 22 for supporting the rotating shaft 28, which will be described later, is fitted in the fixed cylinder portion 20C. An insertion hole 20C1 for inserting a rotating shaft 28, which will be described later, is formed through the bottom wall of the fixed cylinder portion 20C, and the inside of the first bearing 22 and the outside of the housing 20 are communicated with each other by the insertion hole 20C1.

<Plate Holder 24>

The plate holder 24 is formed in a roughly circular plate shape with the vertical direction as the plate thickness direction, and is fitted in the intermediate portion in the vertical direction of the housing 20. An insertion hole 24A for inserting a rotating shaft 28, which will be described later, is formed through the central portion of the plate holder 24. Further, a second bearing 26 for supporting the rotating shaft 28, which will be described later, is fixed to the central portion of the plate holder 24, and the second bearing 26 and the first bearing 22 are arranged coaxially.

<Rotating Shaft 28>

The rotating shaft 28 is formed in the shape of a round bar extending in the vertical direction, and is arranged coaxially with the housing 20 inside the housing 20. The portion of the lower end side of the rotating shaft 28 is rotatably supported by the first bearing 22, and the portion of the upper end side of the rotating shaft 28 is rotatably supported by the second bearing 26. The upper end of the rotating shaft 28 projects upward with respect to the plate holder 24, and the magnet 30 is fixed to the upper end. On the other hand, the lower end portion of the rotating shaft 28 projects downward with respect to the bottom wall of the housing 20, and the gear 32 connected to the steering device is fixed to the lower end portion.

<Stator 34>

The stator 34 is arranged inside the housing 20 on the lower side of the plate holder 24 and on the outer side in the radial direction of the rotating shaft 28. The stator 34 has a stator core 36 made of a magnetic material, and the stator core 36 is formed in a cylindrical shape and is fitted inside the housing 20. Further, a winding 38 corresponding to the U-phase, the V-phase, and the W-phase is wound around the stator core 36.

<Rotor 40>

The rotor 40 has a rotor core 42, and the rotor core 42 is formed in a cylindrical shape with the vertical direction as the axial direction, and is arranged inside the stator 34 in the radial direction. The rotating shaft 28 is fitted into the shaft core portion of the rotor core 42, and the rotor core 42 (rotor 40) and the rotating shaft 28 are configured to be integrally rotatable. Further, a plurality of magnets 44 (permanent magnets) are fixed in the rotor core 42. As a result, the rotor 40 and the rotating shaft 28 are integrally rotated around the axis AL by passing a current through the U-phase, V-phase, and W-phase windings 38 of the stator 34.

<Bus-Bar Unit 46>

The bus-bar unit 46 is arranged above the stator 34 and is held by the plate holder 24. The bus-bar unit 46 comprises three bus-bars 48 corresponding to the U-phase, V-phase, and W-phase windings 38 of the stator 34, and a bus-bar holder 50 for holding the bus-bar 48. One end of the bus-bar 48 is connected to each of the U-phase, V-phase, and W-phase windings 38 of the stator 34. As shown in FIG. 3, the other end of the bus-bar 48 is configured as a bus-bar terminal 48A, and the bus-bar terminal 48A projects upward from the plate holder 24 and is arranged side by side in the second direction. Further, the bus-bar terminal portion 48A is formed in a roughly long plate shape having the first direction as the plate thickness direction and extending in the vertical direction. The bus-bar terminal portion 48A is connected to the connection terminal 86 of the connector 80 described later.

(ECU Unit 14)

As shown in FIGS. 1 to 3, the ECU unit 14 is assembled to the open end of the housing 20 to form the upper end of the rotary electric machine 10. The ECU unit 14 comprises a heat-sink 60, a circuit board 70 as a “substrate” for controlling the motor portion 12, and a connector assembly 90 connected to the circuit board 70.

<Heat-Sink 60>

As shown in FIGS. 1 to 7, the heat-sink 60 is made of an aluminum alloy or the like having high thermal conductivity. The heat-sink 60 is formed in a roughly disk shape with the vertical direction as the plate thickness direction. A flange portion 60A extending radially outward is integrally formed on the outer peripheral portion of the upper end portion of the heat-sink 60, and the flange portion 60A is formed over the entire circumference of the heat-sink 60 in the circumferential direction. The heat-sink 60 is fitted into the opening of the housing 20 from above, and the flange portion 60A is arranged adjacent to the upper side of the opening end surface of the housing 20. As a result, the opening of the housing 20 is closed by the heat-sink 60. That is, the heat-sink 60 is configured as the lid portion of the housing 20, and also constitutes a part of the outer shell of the rotary electric machine 10.

Further, the flange portion 60A is integrally formed with three first fixing portions 60B protruding outward in the radial direction at positions corresponding to the screw portions 20B1 of the housing 20. A fixing hole 60B1 is formed through the first fixing portion 60B. The heat-sink 60 is fixed to the housing 20 by inserting the fixing screw SC1 into the fixing hole 60B1 from above and screwing it into the screw portion 20B1 of the housing 20.

Further, A pair of second fixing portions 60C extending outward in the radial direction are integrally formed on the portion of the flange portion 60A on the other side in the first direction, and the second fixing portions 60C are arranged side by side in the circumferential direction of the heat-sink 60. A first fixing screw portion 60C1 for fixing the connector assembly 90, which will be described later, is formed through the second fixing portion 60C, and a female screw is formed on the inner peripheral surface of the first fixing screw portion 60C1.

A seal groove 60D is formed in the vertical intermediate portion of the outer peripheral portion of the heat-sink 60. The seal groove 60D is opened to the outside in the radial direction of the heat-sink 60, and extends over the entire circumference of the heat-sink 60 in the circumferential direction. A ring-shaped O-ring OL is housed in the seal groove 60D, and the O-ring OL is made of an elastic member such as rubber. In the fixed state of the heat-sink 60 to the housing 20, the O-ring OL is elastically deformed and is in close contact with the inner peripheral surface of the seal groove 60D and the inner peripheral surface of the housing 20. As a result, the space between the heat-sink 60 and the open end of the housing 20 is sealed by the O-ring OL to ensure the airtightness inside the housing 20.

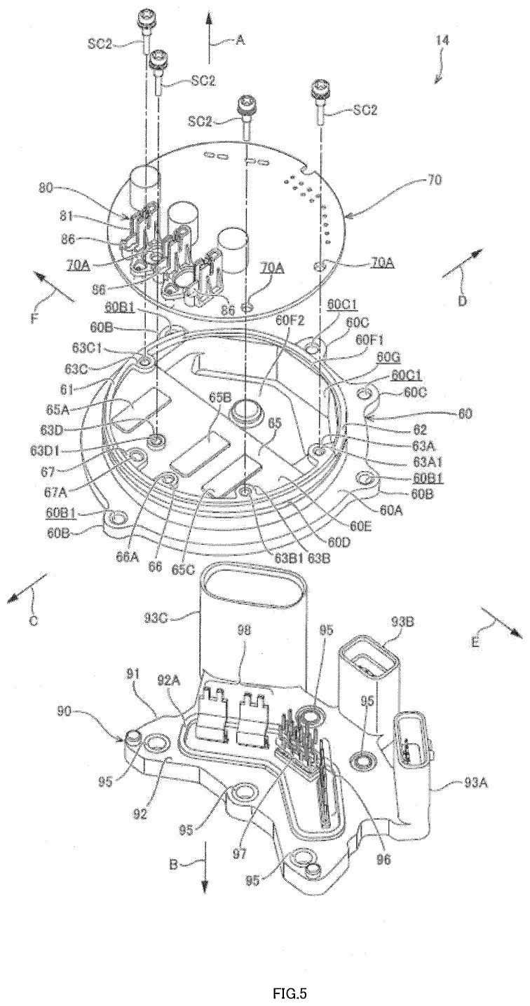

As shown in FIGS. 5 and 7, an installation portion 61 for installing the circuit board 70, which will be described later, is formed on the outer peripheral portion of the lower surface 60E of the heat-sink 60. The installation portion 61 projects downward from the lower surface 60E of the heat-sink 60 and is formed in a rib shape extending along the circumferential direction of the heat-sink 60. Further, most of the installation portion 61 is formed on the outer peripheral portion of the heat-sink 60 on one side in the first direction and when viewed from below, the installation portion 61 is formed in a roughly C shape that is open to the other side in the first direction. That is, on the outer peripheral portion of the lower surface 60E of the heat-sink 60, a step portion 62 which is one step lower to the upper side than the installation portion 61 is formed on the portion on the other side in the first direction. The vertical position of the step portion 62 is set so that the step portion 62 is substantially flush with the lower surface 60E of the heat sink 60. Further, both ends in the longitudinal direction of the installation portion 61 are arranged on the other side in the first direction with respect to the second reference line L2 in a bottom view (cf. FIG. 7). That is, the length of the installation portion 61 in the longitudinal direction is set to ½ or more of the total length in the circumferential direction of the heat-sink 60.

Further, the installation portion 61 has three first substrate fixing portions 63A, a second substrate fixing portion 63B, and a third substrate fixing portion 63C protruding inward in the radial direction of the heat-sink 60, wherein the tip surface (lower surface) of the first substrate fixing portion 63A to the third substrate fixing portion 63C is arranged flush with the tip surface (lower surface) of the installation portion 61. The first substrate fixing portion 63A, the second substrate fixing portion 63B, and the third substrate fixing portion 63C are respectively formed with a concave first substrate fixing screw portion 63A1, the second substrate fixing screw portion 63B1, and the third substrate fixing screw portion 63C1 that is open downward. Female threads are formed on the inner peripheral surfaces of the first substrate fixing screw portion 63A1, the second substrate fixing screw portion 63B1, and the third substrate fixing screw portion 63C1.

Further, the first substrate fixing portion 63A is formed at one end in the longitudinal direction of the installation portion 61, and arranged on one side in the second direction (arrow E direction side in FIG. 7) with respect to the first reference line L1 and on the other side in the first direction with respect to the second reference line L2. The second substrate fixing portion 63B is formed on one side in the longitudinal direction of the installation portion 61. Specifically, the second substrate fixing portion 63B is arranged on one side in the second direction with respect to the first reference line L1 and on one side in the first direction with respect to the second reference line L2, in a bottom view. The third substrate fixing portion 63C is formed on the other side portion in the longitudinal direction of the installation portion 61. Specifically, the third substrate fixing portion 63C is arranged on the other side in the second direction (arrow F direction side in FIG. 7) with respect to the first reference line L1 and slightly deviated from the one side in the first direction with respect to the second reference line L2, in the bottom view.

Further, a fourth substrate fixing portion 63D for fixing the circuit board 70, which will be described later, is formed on the lower surface 60E of the heat-sink 60. The fourth substrate fixing portion 63D is formed in a roughly cylindrical shape having a relatively low height protruding downward, and the tip surface (lower surface) of the fourth substrate fixing portion 63D is arranged flush with the tip surface (lower surface) of the installation portion 61. A fourth substrate fixing screw portion 63D1 is formed inside the fourth substrate fixing portion 63D, and a female screw is formed on the inner surface of the fourth substrate fixing screw portion 63D1. Further, the fourth substrate fixing portion 63D is arranged at a position on the other side in the second direction with respect to the first reference line L1 and on one side in the first direction with respect to the second reference line L2 in the bottom view.

Further, a portion of the heat-sink 60 on one side in the first direction (specifically, the portion on one side in the first direction from the position slightly deviated to the other side of the first direction with respect to the second reference line L2) is configured as a heat dissipating portion 65 for dissipating heat generated by the FET 74 of the circuit board 70, which will be described later. The heat dissipating portion 65 is formed with a first heat dissipating portion 65A, a second heat dissipating portion 65B, and a third heat dissipating portion 65C protruding downward from the lower surface 60E of the heat-sink 60. The first heat dissipating portion 65A to the third heat dissipating portion 65C are formed in a roughly rectangular shape with the first direction as the longitudinal direction, in the bottom view. The amount of protrusion from the lower surface 60E of the first heat dissipating portion 65A to the third heat dissipating portion 65C is set to be smaller than the amount of protrusion from the lower surface 60E of the installation portion 61. That is, the lower surfaces of the first heat dissipating portion 65A to the third heat dissipating portion 65C are arranged above the lower surface of the installation portion 61.

Further, the first heat dissipating portion 65A to the third heat dissipating portion 65C are arranged side by side at a predetermined interval in the second direction. Specifically, the first heat dissipating portion 65A is arranged between the third substrate fixing portion 63C and the fourth substrate fixing portion 63D, in a bottom view. In other words, the third substrate fixing portion 63C, the first heat dissipating portion 65A, and the fourth substrate fixing portion 63D are arranged side by side in this order on one side in the second direction.

The second heat dissipating portion 65B and the third heat dissipating portion 65C are arranged side by side in the second direction at positions between the second substrate fixing portion 63B and the fourth substrate fixing portion 63D, in a bottom view. In other words, the fourth substrate fixing portion 63D, the second heat dissipating portion 65B, the third heat dissipating portion 65C, and the second substrate fixing portion 63B are arranged side by side in this order on one side in the second direction.

Further, a pair of positioning portions 66, 67 for determining the position of the connector 80 of the circuit board 70, which will be described later, are formed on the lower surface 60E of the heat-sink 60. The positioning portions 66 and 67 project downward from the lower surface 60E of the heat-sink 60, and the amount of protrusion from the lower surface 60E of the positioning portions 66 and 67 is set to be smaller than the amount of protrusion from the lower surface 60E of the installation portion 61. Further, the positioning portions 66 and 67 are arranged on the outer peripheral side of the lower surface 60E of the heat-sink 60 on one side in the first direction, and are arranged adjacent to the inner side in the radial direction of the installation portion 61. Specifically, the pair of positioning portions 66, 67 are arranged at positions symmetrical with respect to the first reference line L1 in the second direction in the bottom view.

A concave first heat-sink side positioning hole 66A opened downward is formed on the lower surface of the positioning portion 66 on one side in the second direction, and the first heat-sink side positioning hole 66A is formed in a circular shape when viewed from the bottom. On the other hand, a concave second heat-sink side positioning hole 67A opened downward is formed on the lower surface of the positioning portion 67 on the other side in the second direction, and the second heat-sink side positioning hole 67A is formed in a roughly track shape with the second direction as the longitudinal direction when viewed from the bottom. That is, the heat-sink 60 is formed with a pair of first heat-sink side positioning holes 66A and second heat-sink side positioning holes 67A, and the first heat-sink side positioning hole 66A and the second heat-sink side positioning hole 67A are arranged side by side in the second direction. The width direction (first direction) of the second heat-sink side positioning hole 67A is set to match the diameter of the first heat-sink side positioning hole 66A.

The portion of the lower surface 60E of the heat sink 60 on the other side in the first direction, a first recess 60F1 opened downward is formed on the radial inside of the step portion 62. The first recess 60F1 is formed in a roughly semicircular shape when viewed from the bottom surface, and the bottom surface (lower surface) of the first recess 60F1 is arranged above the step portion 62. Further, the first recess 60F1 is formed with a second recess 60F2 that is open downward, and the second recess 60F2 is formed in a roughly hexagonal shape in a bottom view. The first recess 60F1, the second recess 60F2, and the step portion 62 correspond to the “displacement allowing portion” of the present invention. Further, a terminal insertion portion 60G as an “insertion portion” for inserting the first terminal 96, the second terminal 97, and the third terminal 98 of the connector assembly 90, which will be described later, is formed through the portion of the second recess 60F2 on the other side in the first direction. The terminal insertion portion 60G is formed in a roughly V shape open to one side in the first direction in a bottom view.

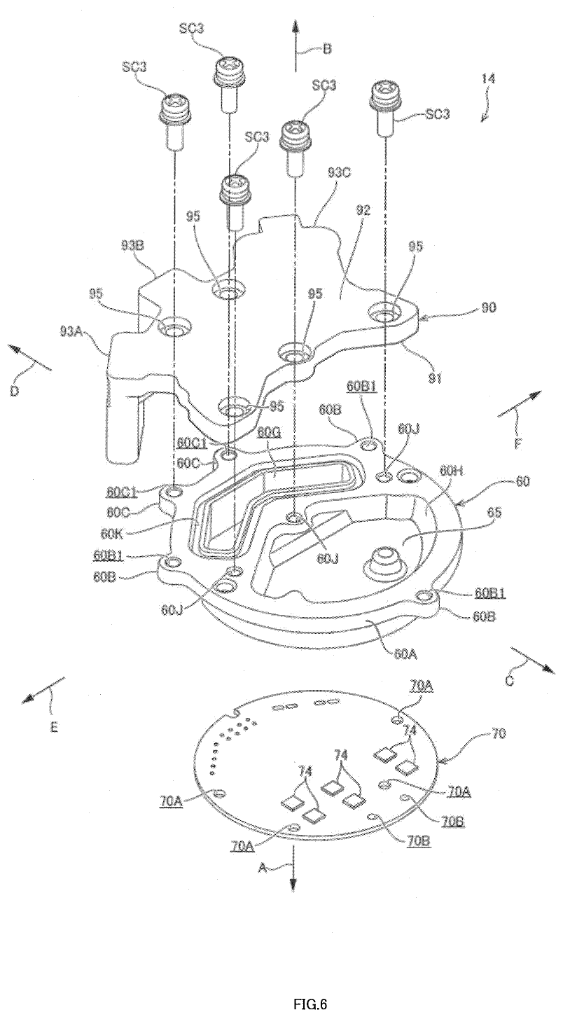

As shown in FIG. 6, on the upper surface of the heat-sink 60, a relief 60H opened upward is formed on the portion on one side in the first direction, and the relief 60H is formed in a roughly fan shape in a plan view.

Further, on the upper surface of the heat-sink 60, a plurality of (three places in this embodiment) second fixing screw portions 60J for fixing the connector assembly 90, which will be described later, are formed at positions between the relief 60H and the terminal insertion portion 60G. The second fixing screw portion 60J is formed in a concave shape that is open to the upper side of the heat-sink 60, and a female screw is formed on the inner peripheral surface of the second fixing screw portion 60J. The second fixing screw portions 60J at three locations are arranged at predetermined intervals in the second direction in a plan view.

Further, a fitting groove 60K is formed on the upper surface of the heat sink 60 at the peripheral edge of the terminal insertion portion 60G. The fitting groove 60K is opened upward and is formed in a frame shape extending along the circumferential direction of the terminal insertion portion 60G. That is, the fitting groove 60K is formed in a roughly V-shaped frame shape that is open to one side in the first direction when viewed from the bottom. As a result, the terminal insertion portion 60G is surrounded by the fitting groove 60K.

<Circuit Board 70>

As shown in FIGS. 1-8, the circuit board 70 is formed in a disk shape with the vertical direction as the plate thickness direction, and the diameter of the circuit board 70 is set to be slightly smaller than the diameter of the heat-sink 60. The circuit board 70 is arranged coaxially with the heat sink 60, and a part of the outer peripheral portion on the upper surface of the circuit board 70 is installed on the lower surface of the installation portion 61 of the heat sink 60. As a result, the circuit board 70 is arranged adjacent to the lower side of the heat sink 60 (that is, the motor portion 12 side). Further, a gap G (cf. FIG. 4B) is formed in the vertical direction between the outer peripheral portion of the circuit board 70 on the other side in the first direction and the step portion 62 of the heat-sink 60. That is, the outer peripheral portion of the lower side (motor portion 12 side) of the heat sink 60 described above is composed of the installation portion 61 on which the circuit board 70 is installed and the step portion 62 that is one step lower than the motor portion 12 with respect to the tip surface (lower end surface) of the installation portion 61 and separated upward from the circuit board 70. Further, in a plan view, the entire circuit board 70 is arranged so as to lap (overlap) the heat sink 60, and the outer peripheral surface of the circuit board 70 is arranged inside the housing 20 along the inner peripheral surface of the housing 20.

Further, the circuit board 70 is formed through four substrate fixing holes 70A (cf. FIG. 6) at positions corresponding to the first substrate fixing screw portions 63A1 to the fourth substrate fixing screw portion 63D1 of the heat-sink 60. The circuit board 70 is fixed to the heat-sink 60 by inserting the fixing screw SC2 into the substrate fixing hole 70A from below and screwing it into the first substrate fixing screw portion 63A1 to the fourth substrate fixing screw portion 63D1.

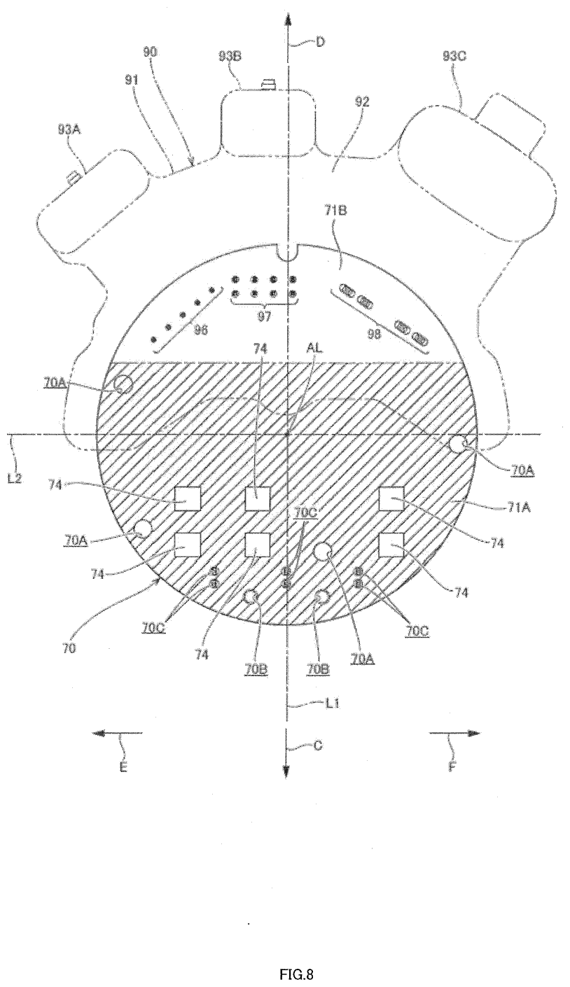

As a result, the circuit board 70 is divided into a first substrate portion 71A (hatched part in FIG. 8) fixed to the heat sink 60 and a second substrate portion 71B (parts not hatched in FIG. 8) not fixed to the heat sink 60 in the first direction. Specifically, the outer peripheral portion of the first substrate portion 71A is installed in the installation portion 61 (including the first substrate fixing portion 63A, the second substrate fixing portion 63B, and the third substrate fixing portion 63C) of the heat sink 60, and a portion of the first substrate portion 71A on one side in the first direction is installed in the fourth substrate fixing portion 63D. Therefore, the boundary portion between the first substrate portion 71A and the second substrate portion 71B is displaced to the other side in the first direction with respect to the second reference line L2. The entire second substrate portion 71B is vertically opposed to the first recess 60F1, the second recess 60F2, and the step portion 62 of the heat sink 60, and is arranged so as to be separated from the heat sink 60 on the lower side. As a result, in the circuit board 70, the displacement in the plate thickness direction (vertical direction) of the second substrate portion 71B is allowed by the first recess 60F1, the second recess 60F2, and the step portion 62 of the heat sink 60.

A magnetic sensor 72 is provided (mounted) at the center of the lower surface (one side surface) of the circuit board 70. The magnetic sensor 72 is arranged close to the upper side of the magnet 30 on the rotating shaft 28 of the motor portion 12, and the magnetic sensor 72 and the magnet 30 are arranged so as to face each other in the vertical direction (cf. FIG. 2). As a result, the rotation amount (rotation angle) of the rotating shaft 28 is detected by the magnetic sensor 72.

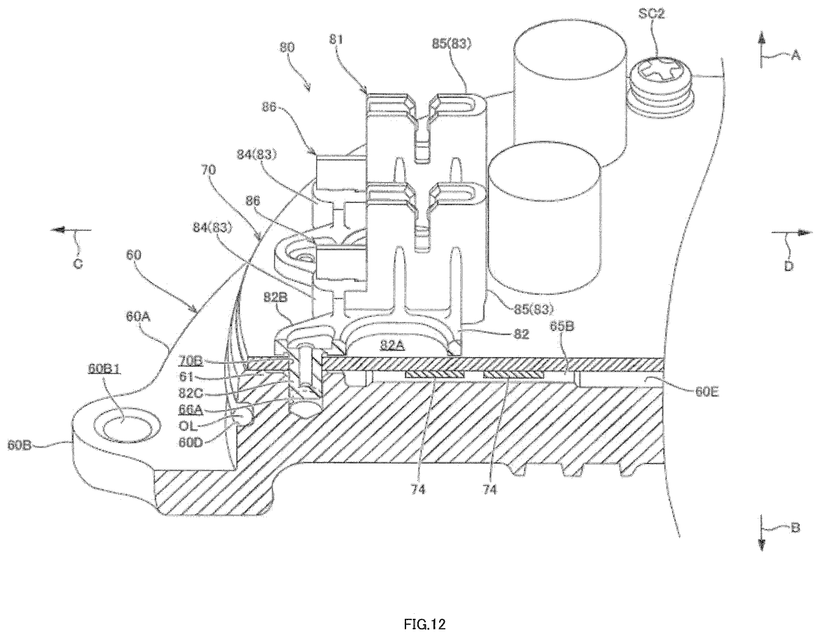

On the other hand, as shown in FIGS. 6 and 7, a plurality of FETs 74 (heat generating element) are provided (mounted) on the upper surface of the first substrate portion 71A in the circuit board 70 (the surface facing the heat sink 60) in a region facing the heat dissipating portion 65 of the heat-sink 60 vertically. The plurality of FETs 74 are arranged at positions corresponding to the first heat dissipating portion 65A, the second heat dissipating portion 65B, and the third heat dissipating portion 65C of the heat-sink 60. Specifically, on the circuit board 70, a pair of FETs 74 are respectively arranged at positions corresponding to the first heat dissipating portion 65A, the second heat dissipating portion 65B, and the third heat dissipating portion 65C of the heat-sink 60, and the paired FETs 74 are arranged side by side in the first direction (cf. FIG. 7). As a result, the plurality of FETs 74 are arranged radially inside the installation portion 61 in a bottom view. Further, in the fixed state of the circuit board 70 to the heat-sink 60, the amount of protrusion is set from the lower surface 60E of the heat-sink 60 of the first heat dissipating portion 65A, the second heat dissipating portion 65B, and the third heat dissipating portion 65C so that a slight gap is formed in the vertical direction between the FET 74 and the first heat dissipating portion 65A, the second heat dissipating portion 65B, and the third heat dissipating portion 65C (cf. FIG. 12). Grease for heat dissipation or the like is interposed in the gap.

Further, a pair of circular substrate-side positioning holes 70B (cf. FIG. 6) are formed through the first substrate portion 71A of the circuit board 70 at positions corresponding to the first heat-sink-side positioning holes 66A and the second heat-sink-side positioning holes 67A of the heat-sink 60. The diameter dimension of the substrate side positioning hole 70B is set to be roughly the same as the diameter dimension of the first heat-sink side positioning hole 66A.

Further, as shown in FIGS. 3, 4 and 5, on the lower surface of the first substrate portion 71A of the circuit board 70, a connector 80 for connecting the circuit board 70 and the motor portion 12 (three bus-bars 48) is provided on one side of the first direction (specifically, the position corresponding to the bus-bar terminal 48A described above). Hereinafter, the connector 80 will be described.

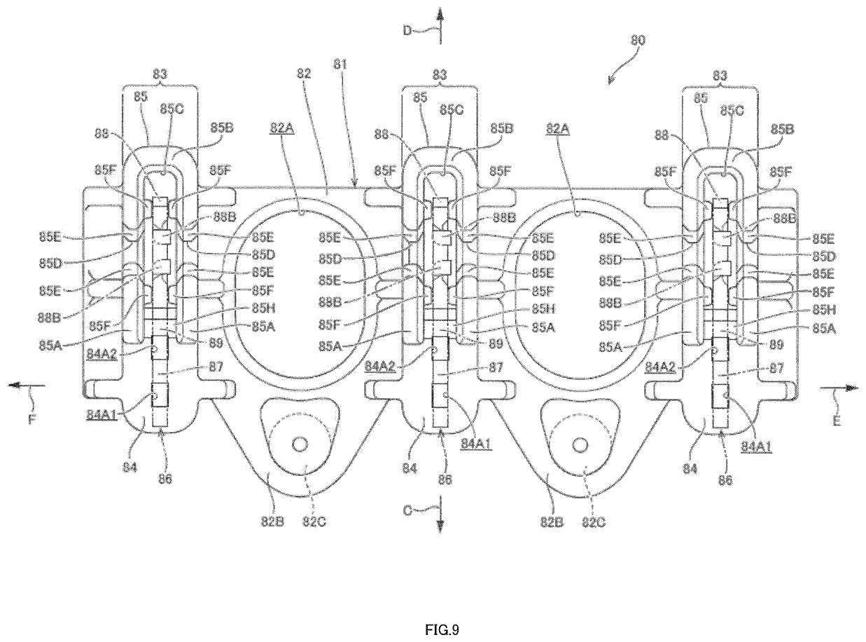

As shown in FIGS. 3, 4, 5, and 9-12, the connector 80 comprises three connection terminals 86 and a terminal holder 81 as a “holder” for holding the three connection terminals 86. The bus-bar terminal 48A of the bus-bar 48 is press-fitted into the connection terminal 86 to connect the motor portion 12 and the connection terminal 86. That is, the connector 80 is configured as a so-called press-fit connector.

[Terminal Holder 81]

The terminal holder 81 is made of a resin material (insulating material). The terminal holder 81 is formed in a roughly E-shaped block shape that is open downward when viewed from the first direction. Specifically, the terminal holder 81 comprises a base portion 82 that constitutes a base end portion (upper end) of the terminal holder 81, and three holding main body portions 83 that protrude downward (motor portion 12 side) from the base portion 82.

The base portion 82 is formed in a roughly rectangular plate shape with the vertical direction as the plate thickness direction and the second direction as the longitudinal direction, and is installed on the lower surface of the circuit board 70. The base portion 82 is arranged with respect to the circuit board 70 so that the central portion of the base portion 82 in the longitudinal direction coincides with the first reference line L1 in the bottom view (cf. FIG. 4). A pair of hole portions 82A are formed through the base portion 82, and the hole portions 82A are arranged at positions symmetrical with respect to the first reference line L1 in the second direction when viewed from the bottom. The hole 82A is formed in a roughly track shape with the first direction as the longitudinal direction. The head of the fixing screw SC2 is arranged in the hole 82A on the other side in the second direction.

Further, the base portion 82 is integrally formed with a pair of positioning pieces 82B extending to one side in the first direction at positions corresponding to the pair of hole portions 82A. Each positioning pin 82C is formed at the tip of the positioning piece 82B, and the positioning pin 82C is formed in a bottomed cylindrical shape that protrudes upward (circuit board 70 side) from the positioning piece 82B and is open downward. Further, the diameter of the positioning pin 82C is set to be roughly the same as the diameter of the substrate side positioning hole 70B of the circuit board 70 and the first heat-sink side positioning hole 66A of the heat-sink 60.

The positioning pin 82C on one side in the second direction is fitted in the positioning hole 70B on the substrate side of the circuit board 70 and in the positioning hole 66A on the first heat-sink side of the heat-sink 60 (cf. FIG. 12). Further, the positioning pin 82C on the other side in the second direction is fitted in the substrate side positioning hole 70B of the circuit board 70 and in the second heat-sink side positioning hole 67A of the heat-sink 60. As a result, the position of the terminal holder 81 (that is, the connector 80) with respect to the heat-sink 60 is determined by the positioning pin 82C.

The three holding main body portions 83 project downward from both ends in the longitudinal direction and the central portion in the longitudinal direction of the base portion 82, respectively. The holding main body portion 83 extends along the width direction (first direction) of the base portion 82 in a bottom view. Further, the holding main body portion 83 comprises a holder portion 84 that constitutes one end of the holding main body portion 83 in the first direction, and a cover portion 85 that constitutes the other end of the holding main body portion 83 in the first direction.

The holder portion 84 is formed in the shape of a roughly rectangular parallelepiped block protruding downward from the base portion 82. A pair of holding holes 84A1 and 84A2 are formed in the holder portion 84 in the central portion in the width direction (second direction) of the holding main body portion 83, and the holding holes 84A1 and 84A2 are penetrated in the vertical direction. That is, the holding holes 84A1 and 84A2 also penetrate the base portion 82. The holding holes 84A1 and 84A2 are formed in a roughly rectangular shape in a bottom view and are arranged side by side along the first direction. Further, the holding hole 84A2 arranged on the other side in the first direction is arranged at the end on the other side in the first direction of the holder portion 84, and at the end of the holder portion 84 on the other side in the first direction, the holding hole 84A2 is opened to the other side in the first direction in a bottom view. Further, the dimensions of the holding holes 84A1 and 84A2 in the second direction are set to be slightly larger than the plate thickness of the connection terminal 86 described later.

The cover portion 85 is formed in a roughly U-shaped columnar shape open to one side in the first direction in a bottom view, and is formed in a roughly flat shape with the second direction as the thickness direction. Specifically, the cover portion 85 comprises a pair of first side walls 85A with the second direction as the plate thickness direction, and a second side wall 85B connecting the ends of the pair of first side walls 85A on the other side in the first direction. The amount of protrusion of the cover portion 85 from the base portion 82 is significantly larger than the amount of protrusion of the holder portion 84 from the base portion 82. Further, one side end in the first direction at the base end of the pair of first side walls 85A is connected to the holder 84. The inside of the cover portion 85 is configured as an accommodating portion 85C for accommodating the connection terminal 86 described later.

A guide groove 85D is formed at the tip end portion (lower end portion) of the pair of first side wall 85A at the intermediate portion in the first direction. The guide groove 85D is formed in a slit shape extending in the vertical direction and is penetrated in the second direction. A pair of inclined portions 85E are formed at the opening end of the guide groove 85D, and the inclined portions 85E are inclined in a direction (outside of the guide groove 85D in the width direction) in which they are separated from each other toward the lower side (opening side of the guide groove 85D). Further, the groove width of the guide groove 85D is set to be slightly larger than the plate thickness of the bus-bar terminal portion 48A, and in the connected state between the connection terminal 86 and the bus-bar terminal 48A, which will be described later, the bus-bar terminal 48A is inserted into the guide groove 85D.

A pair of guide ribs 85F are formed on the inner peripheral surfaces of the pair of first side walls 85A. The guide ribs 85F are arranged on one side and the other side in the first direction with respect to the guide groove 85D, respectively, and extend downward from the base portion 82. The guide ribs 85F arranged to face each other in the second direction form a set, and the separation distance of the set guide ribs 85F in the second direction is set so as to roughly match the plate thickness of the connection terminal 86 described later. An inclined surface 85G is formed at the tip of the guide rib 85F, and the inclined surface 85G is inclined toward the first side wall 85A toward the lower side.

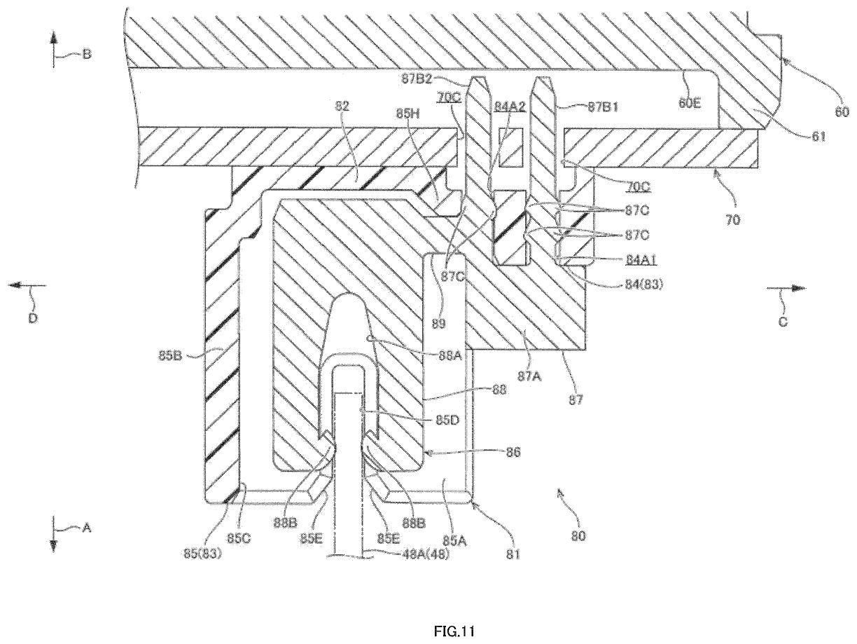

Further, in the accommodating portion 85C of the cover portion 85, a support protrusion portion 85H (cf. FIG. 11) is provided at a boundary portion of the holder portion 84 with the holding hole 84A2 arranged on the other side in the first direction. The support protrusion 85H protrudes downward from the base portion 82, and the amount of protrusion of the support protrusion 85H from the base portion 82 is smaller than the amount of protrusion of the holder portion 84 from the base portion 82. Further, the support protrusion 85H is formed in a roughly trapezoidal shape in a cross-sectional view seen from the second direction.

[Connection Terminal 86]

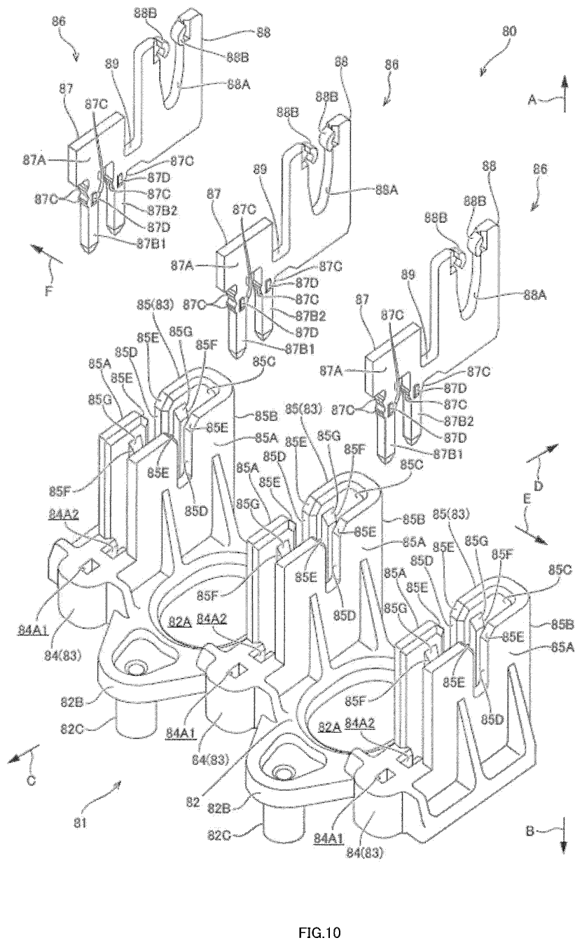

As shown in FIGS. 10 and 11, the connection terminal 86 is made of a metal plate material. Further, the connection terminals 86 are arranged with the second direction as the plate thickness direction, and are held by the holding main body portions 83 at three locations in the terminal holder 81, respectively. That is, the three connection terminals 86 are arranged side by side in the second direction. Further, as described above, the head of the fixing screw SC2 is arranged in the hole 82A on the other side in the second direction of the terminal holder 81. Therefore, the circuit board 70 is fixed to the heat sink 60 at a position between the connection terminal 86 in the center of the second direction and the connection terminal 86 on the other side in the second direction.

The connection terminal 86 is formed in a roughly crank-shaped plate shape when viewed from the second direction. Specifically, the connection terminal 86 is configured to include a terminal fixing portion 87 constituting one end of the connection terminal 86 (one end on one side in the first direction), terminal connection portion 88 constituting the other end of the connection terminal 86 (end on the other side in the first direction), and the connecting portion 89 that connects the terminal fixing portion 87 and the terminal connecting portion 88.

The terminal fixing portion 87 is formed in a roughly inverted U-shaped plate shape that is open to the upper side (circuit board 70 side) when viewed from the second direction. Specifically, the terminal fixing portion 87 comprises a base portion 87A constituting the lower end portion of the terminal fixing portion 87, and a pair of terminal portions 87B1 and 87B2 extending upward from the base portion 87A. The base portion 87A is formed in a roughly rectangular plate shape, and is arranged adjacent to the lower side of the holder portion 84 of the terminal holder 81. The pair of terminal portions 87B1 and 87B2 are arranged side by side in the first direction corresponding to the pair of holding holes 84A1 and 84A2 in the holder portion 84 of the terminal holder 81.

Further, a plurality of (four locations in the present embodiment) protruding portions 87C are integrally formed at the base end portion (lower end portion) of the terminal portion 87B1 arranged on one side in the first direction. Specifically, the two protruding portions 87C are projected from the base end portion of the terminal portion 87B1 to one side in the first direction, and are arranged side by side in the vertical direction. Further, the other two protrusions 87C are projected from the base end portion of the terminal portion 87B1 to the other side in the first direction, and are arranged side by side in the vertical direction. The protrusion 87C is formed in a roughly wedge shape when viewed from the second direction. The terminal portion 87B1 is fitted into the holding hole 84A1 from below so that the protrusion 87C wedges into the inner peripheral surface of the holding hole 84A1 of the terminal holder 81. As a result, the terminal portion 87B1 (that is, the connection terminal 86) is held by the terminal holder 81.

Further, a plurality of (in this embodiment, two locations) protrusions 87C are integrally formed on the base end side of the terminal portion 87B2 arranged on the other side in the first direction, and the protrusion 87C protrudes from the terminal portion 87B2 to one side in the first direction and the other side in the second direction. The terminal portion 87B2 is fitted into the holding hole 84A2 from below so that the protruding portion 87C wedges into the inner peripheral surface of the holding hole 84A2 of the terminal holder 81. As a result, the terminal portion 87B2 (that is, the connection terminal 86) is held by the terminal holder 81.

Further, protruding portions 87D (cf. FIG. 10) projecting to one side in the second direction are formed on the portions on the base end side of the terminal portions 87B1 and 87B2, respectively, and the protruding portion 87D is formed by a half blanking process or the like. The terminal portions 87B1, 87B2 are fitted into the holding holes 84A1, 84A2 in a state where the protruding portion 87D is in pressure contact with the inner peripheral surfaces of the holding holes 84A1, 84A2 of the terminal holder 81.

Further, the tip portions (upper end portions) of the pair of terminal portions 87B1 and 87B2 project upward than the terminal holder 81 (the circuit board 70 side) and are inserted into the terminal hole 70C of the circuit board 70, and fixed to the circuit board 70 by soldering (cf. FIG. 11). In FIG. 11, for convenience, the solder for fixing the pair of terminal portions 87B1 and 87B2 and the circuit board 70 is not shown.

The terminal connection portion 88 is formed in a roughly U-shaped plate shape that is open to the lower side (motor portion 12 side) when viewed from the second direction. That is, the terminal connection portion 88 is formed with a press-fitting groove 88A that is open downward. The groove width on the opening side of the press-fitting groove 88A is set to be larger than the groove width of the guide groove 85D of the terminal holder 81. On the other hand, the groove width on the bottom side of the press-fitting groove 88A is set to become smaller toward the bottom of the press-fitting groove 88A.

A terminal press-fitting portion 88B is respectively formed at the open end of the press-fitting groove 88A. The terminal press-fitting portion 88B is bent to one side in the second direction, and is formed in a roughly semicircular shape that is convex inward in the groove width direction of the press-fitting groove 88A when viewed from the second direction. The distance between the pair of terminal press-fitting portions 88B in the first direction is set to be slightly shorter than the plate thickness of the bus-bar terminal portion 48A.

Further, the terminal connection portion 88 is housed in the accommodating portion 85C of the terminal holder 81, and the entire terminal connection portion 88 is covered by the cover portion 85 of the terminal holder 81. In the state of accommodating the terminal connection portion 88 in the accommodating portion 85C, the lower end of the terminal connection portion 88 is arranged on the upper side of the inclined portion 85E of the terminal holder 81, and in the first direction, the guide groove 85D of the terminal holder and the press-fitting groove 88A of the terminal connection portion 88 are arranged at the same positions. Specifically, when viewed from the second direction, a part (top portion of the arc-shape) of the pair of terminal press-fitting portions 88B is arranged at a position above than the inclined portion 85E of the terminal holder 81, and at the same time, the guide groove 85D is arranged so as to project inward in the groove width direction. As a result, the bus-bar terminal portion 48A of the bus-bar 48 is press-fitted between the pair of terminal press-fitting portions 88B, and the terminal press-fitting portion 88B is press-fitted to the bus-bar terminal portion 48A. In other words, the bus-bar terminal portion 48A is press-fitted and fixed to the terminal press-fitting portion 88B.

Further, in this accommodation state, the terminal connection portion 88 is sandwiched in the second direction by the guide rib 85F of the terminal holder 81, and is arranged so as to be separated from the base portion 82 (that is, the circuit board 70) of the terminal holder 81 on the lower side. That is, a gap is formed between the terminal connection portion 88 and the base portion 82, and the terminal connection portion 88 is held by the terminal holder 81 so as to be relatively displaceable in the vertical direction.

The connecting portion 89 is formed in a roughly rectangular plate shape with the second direction as the plate thickness direction, and connects the base end portion of the other terminal portion 87B2 of the terminal fixing portion 87 and the upper end portion of the terminal connection portion 88. That is, the connection terminal 86 is formed in a flat plate shape having no bent portion, except for the terminal press-fitting portion 88B in the terminal connection portion 88. Further, the connecting portion 89 is arranged above than the press-fitting groove 88A (on the circuit board 70 side) and is accommodated in the accommodating portion 85C of the terminal holder 81. That is, the connecting portion 89 and the press-fitting groove 88A are arranged so as to be offset in the vertical direction.

Further, the portion of the connecting portion 89 on the terminal fixing portion 87 side is arranged adjacent to the support protrusion 85H of the terminal holder 81 on the lower side and is in contact with the support protrusion 85H. In other words, the support protrusion 85H supports the portion of the connecting portion 89 on the terminal fixing portion 87 side from the circuit board 70 side. As a result, when an upward press-fitting load acts on the terminal connection portion 88 when the bus-bar 48 is press-fitted into the terminal connection portion 88, the support protrusion 85H is configured to receive the press-fitting load. Further, when a press-fitting load of a predetermined value or more is input to the connecting portion 89, the connecting portion 89 is configured to bend and deform starting from the contact portion with the support protrusion 85H so that the terminal connection portion 88 is displaced toward the circuit board 70 side.

<Connector Assembly 90>

As shown in FIGS. 1 to 6 and FIG. 13, the connector assembly 90 includes a mold portion 91, and a first terminal 96, a second terminal 97, and a third terminal 98 as “terminals” integrally formed with the mold portion 91.

The mold portion 91 is made of a resin material (insulating material) and is configured to include a mold base 92, and a first connector portion 93A, a second connector portion 93B, and a third connector portion 93C (in a broad sense, an element grasped as a “connector portion”) in three places. The mold base 92 is formed in a plate shape with the vertical direction as the plate thickness direction. The mold base 92 is arranged adjacent to the upper side of the portion of the heat sink 60 on the other side in the first direction, and closes the terminal insertion portion 60G of the heat sink 60.

The mold base 92 is provided with five metal collars 95 (in a broad sense, it is an element that can be grasped as a “fixing member”) at positions corresponding to the first fixing screw portion 60C1 and the second fixing screw portion 60J of the heat sink 60. The collar 95 is formed in a cylindrical shape with the vertical direction as the axial direction, and is integrally formed with the mold base 92. Specifically, the collar 95 is embedded in the mold base 92 with both end faces in the axial direction of the collar 95 exposed. Further, the two collars 95 corresponding to the first fixing screw portion 60C1 of the heat sink 60 are, in plan view, arranged between the first connector portion 93A and the second connector portion 93B, and between the second connector portion 93B and the third connector portion 93C, which will be described later, respectively. The mold base (that is, connector assembly 90) is fixed to the heat-sink 60 by inserting the fixing screw SC3 into the collar 95 and screwed into the first fixing screw portion 60C1 and the second fixing screw portion 60J.

The first connector portion 93A, the second connector portion 93B, and the third connector portion 93C are each formed in a tubular shape, and extend downward from the other end in the first direction of the mold base 92. Further, the first connector portion 93A, the second connector portion 93B, and the third connector portion 93C are arranged on the outer side in the radial direction of the upper end portion of the housing 20, and are arranged side by side in the circumferential direction of the housing 20. That is, the first connector portion 93A to the third connector portion 93C are formed in a tubular shape that is open downward.

The mold base 92 (connector assembly 90) is arranged with respect to the circuit board 70 so that the mold base and the FET 74 of the circuit board 70 do not overlap in a plan view (cf. FIG. 8). In other words, the heat dissipating portion 65 of the heat sink 60 is not covered by the mold base 92 (mold portion 91) and is exposed to the outside of the rotary electric machine 10 (cf. FIG. 1).

Further, a fitting rib 92A is formed on the lower surface of the mold base 92 at a position corresponding to the fitting groove 60K of the heat sink 60. The fitting rib 92A is projected downward from the mold base 92 and formed in a frame shape extending along the circumferential direction of the fitting groove 60K of the heat sink 60. Then, the fitting rib 92A is fitted into the fitting groove 60K of the heat sink 60.

Further, the two collars 95 corresponding to the first fixing screw portion 60C1 of the heat sink 60 in the mold base 92 are arranged between the fitting rib 92A and the first connector portion 93A to the third connector portion 93C.

A plurality of the first terminal 96, the second terminal 97, and the third terminal 98 are provided in the mold portion 91, respectively. Specifically, in the connector assembly 90, five first terminals 96, eight second terminals 97, and two third terminals 98 are provided in the mold portion 91.

The first terminal 96 is made of a metal rod and is bent in a roughly U-shape open to the lower side. The longitudinal middle portion of the first terminal 96 is integrally formed with the mold base 92, one end of the first terminal 96 extends downward from the inner portion of the fitting rib 92A in the mold base 92 to insert the terminal insertion portion 60G of the heat sink 60, and the other end of the first terminal 96 extends downward from the top wall of the first connector portion 93A. Then, the tip portion at one end of the first terminal 96 is soldered to the second substrate portion 71B of the circuit board 70 and protrudes downward from the circuit board 70, and the other end of the first terminal 96 is arranged inside the first connector portion 93A.

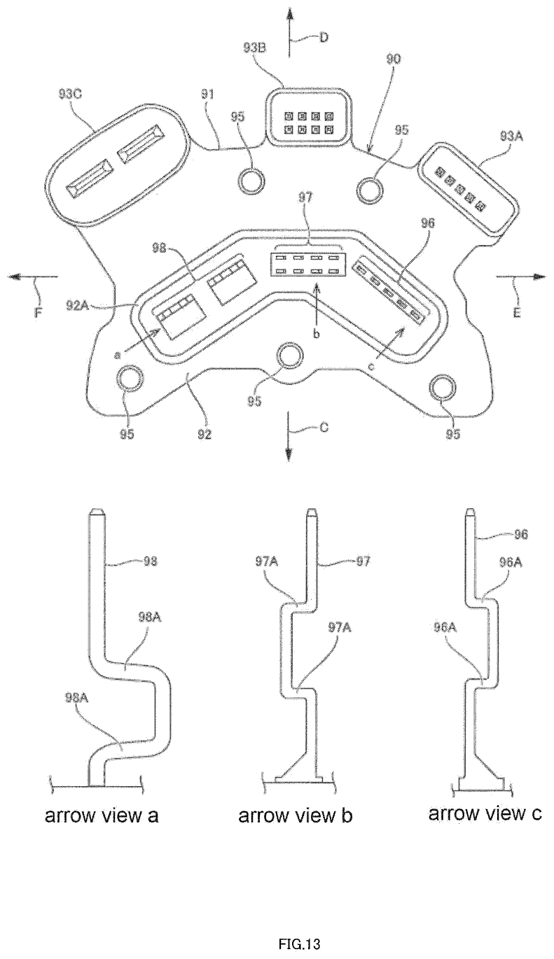

At one end of the first terminal 96, a pair of upper and lower bent portions 96A are formed between the second substrate portion 71B and the mold base 92 (cf. arrow view c of FIG. 13.). The pair of upper and lower bent portions 96A are bent in a crank shape, and one end of the first terminal is formed in a roughly U shape open in a direction orthogonal to the extending direction thereof. It is configured so that when a vertical tensile load or a compressive load of a predetermined value or more is applied to one end of the first terminal 96, one end of the first terminal 96 is bent and deformed (elastic deformation) starting from the bent portion of the bent portion 96A.

Similar to first terminal 96, second terminal 97 is made of a metal rod and is bent into a roughly U-shape that is open downward. The longitudinal middle portion of the second terminal 97 is integrally formed with the mold base 92, one end of the second terminal 97 extends downward from the inner portion of the fitting rib 92A in the mold base 92 to insert the terminal insertion portion 60G of the heat sink 60, and the other end of the second terminal 97 extends downward from the top wall of the second connector portion 93B. The tip of one end of the second terminal 97 is soldered to the second substrate portion 71B of the circuit board 70 and protrudes downward from the circuit board 70, and the other end of the second terminal 97 is arranged inside the second connector portion 93B.

At one end of the second terminal 97, a pair of upper and lower bent portions 97A are formed between the second substrate portion 71B and the mold base 92 (cf. arrow view b of FIG. 13). The pair of upper and lower bent portions 97A are bent in a crank shape, and one end of the second terminal 97 is formed in a roughly U shape open in a direction orthogonal to the extending direction thereof. It is configured so that when a vertical tensile load or a compressive load of a predetermined value or more is applied to one end of the second terminal 97, one end of the second terminal 97 is bent and deformed (elastic deformation) starting from the bent portion of the bent portion 97A.

The third terminal 98 is made of a metal plate. The third terminal 98 is formed in a roughly long plate shape and is bent into a roughly U-shape that is open downward. The longitudinal middle portion of the third terminal 98 is integrally formed with the mold base 92, one end of the third terminal 98 extends downward from the inner portion of the fitting rib 92A in the mold base 92 to insert the terminal insertion portion 60G of the heat sink 60, and the other end of the third terminal 98 extends downward from the top wall of the third connector portion 93C. The tip of one end of the third terminal 98 is soldered to the second substrate portion 71B of the circuit board 70 and protrudes downward from the circuit board 70, and the other end of the third terminal 98 is arranged inside the third connector portion 93C.

At one end of the third terminal 98, a pair of upper and lower bent portions 98A are formed between the second substrate portion 71B and the mold base 92 (cf. arrow view a of FIG. 13). The pair of upper and lower bent portions 98A are bent in a crank shape, and one end of the third terminal is formed in a roughly U shape open in a direction orthogonal to the extending direction thereof. It is configured so that when a vertical tensile load or a compressive load of a predetermined value or more is applied to one end of the third terminal 98, one end of the third terminal 98 is bent and deformed (elastic deformation) starting from the bent portion of the bent portion 98A.

Further, the connector assembly 90 is configured so that the soldered state (solder connection) between the first terminal 96, the second terminal 97, and the third terminal 98, and the circuit board 70 (the second substrate portion 71B) can be visually recognized from the gap G between the step portion 62 of the heat sink 60 and the circuit board 70 (cf. FIG. 14B). Further, an external connector on the vehicle side (not shown) is connected to the first connector portion 93A, the second connector portion 93B, and the third connector portion 93C. As a result, a current is supplied to the circuit board 70 from the vehicle side, a control signal is output, and the motor portion 12 is driven by the control of the circuit board 70.

### Effect

Next, the operation and effect of this embodiment will be described.

In the rotary electric machine 10 configured as described above, the heat sink 60 is assembled to the opening of the housing 20 of the motor portion 12 to close the opening of the housing 20. The mold portion 91 of the connector assembly 90 is fixed to the upper side of the heat sink 60, and the first to third terminals 96, 97, 98 are integrally formed on the mold portion 91. One end of the first to third terminals 96, 97, and 98 extends downward from the mold portion 91. Further, a circuit board 70 is arranged under the heat sink 60. In the first direction, the circuit board 70 is divided into a first substrate portion 71A fixed to the heat sink 60 and a second substrate portion 71B to which one end of the first to third terminals 96, 97, and 98 is soldered.

By the way, when the environmental temperature of the rotary electric machine 10 changes, the circuit board 70, the first to third terminals 96, 97, 98, and the mold portion 91 of the connector assembly 90 are thermally deformed (thermally expanded or contracted). At this time, the first to third terminals 96, 97, 98 tends to be displaced in the vertical direction relative to the circuit board 70 (the second substrate portion 71B) due to the difference in the linear expansion coefficients of each of the circuit board 70, the first to third terminals 96, 97, 98, and the mold portion 91. That is, the first to third terminals 96, 97, 98 act to push the second substrate portion 71B downward or pull it upward. Therefore, the first to third terminals 96, 97, 98 exert a load in the vertical direction on the soldered portion between the first to third terminals 96, 97, 98 and the circuit board 70, and at the same time, a vertical tensile load or compressive load acts on one end of the first to third terminals 96, 97, 98. Thus, stress is generated in the soldered portions of the first to third terminals 96, 97, 98 and the second substrate portion 71B.

Here, the heat sink 60 is formed with a first recess 60F1, a second recess 60F2, and a step portion 62 at a portion facing the second substrate portion 71B in the vertical direction, and the first recess 60F1, the second recess 60F2, and the step portion 62 are arranged so as to be separated from the second substrate portion 71B on the upper side. Therefore, the circuit board 70 is fixed to the heat sink 60 in a state where the displacement of the second substrate portion 71B in the plate thickness direction is allowed by the first recess 60F1, the second recess 60F2, and the step portion 62. As a result, when the first to third terminals 96, 97, 98 tries to be displaced in the vertical direction relative to the circuit board 70 when the environmental temperature of the rotary electric machine 10 changes, the second substrate portion 71B is displaced in the vertical direction following the first to third terminals 96, 97, 98. Therefore, compared with the configuration in which the second substrate portion 71B is fixed to the heat sink 60, the load acting on the soldered portion between the first to third terminals 96, 97, 98 and the second substrate portion 71B can be reduced, and the stress generated in the soldered portion can be alleviated. As a result, it is possible to prevent or suppress the occurrence of cracks or the like in the soldered portion between the first to third terminals 96, 97, 98 and the second substrate portion 71B when the environmental temperature changes. Therefore, the reliability of the rotary electric machine 10 can be improved.

Further, the circuit board 70 is arranged inside the housing 20 of the motor portion 12, and the entire circuit board 70 overlaps the heat sink 60 in a plan view. Therefore, one end of the first to third terminals 96, 97, 98 can be soldered to the second substrate portion 71B without projecting the second substrate portion 71B of the circuit board 70 to the outside in the radial direction of the housing 20. This can contribute to the miniaturization of the circuit board 70 and, by extension, the miniaturization of the rotary electric machine 10.

Further, a bent portion 96A (bent portion 97A, bent portion 98A) bent in a crank shape is formed at one end of the first terminal 96 (second terminal 97, third terminal 98). Therefore, when a vertical tensile load or compressive load of a predetermined value or more acts on one end of first terminal 96 (second terminal 97, third terminal 98) due to a change in the environmental temperature of the rotary electric machine 10, one end of the first terminal 96 (second terminal 97, third terminal 98) is bent and deformed (elastically deformed) starting from the bent portion of the bent portion 96A (bent portion 97A, bent portion 98A). Therefore, the stress acting on the soldered portion between the first to third terminals 96, 97, 98 and the second substrate portion 71B can be further reduced, and the stress acting on one end portion of the first terminal 96 (second terminal 97, third terminal 98) can also be relaxed. Therefore, it is possible to effectively prevent or suppress the occurrence of cracks or the like in the soldered portion between the first to third terminals 96, 97, 98 and the second substrate portion 71B, and also prevent or suppress the damage to the first to third terminals 96, 97, 98.

Further, a plurality of (two places) bent portion 96A (bent portion 97A, bent portion 98A) are formed at one end of the first terminal 96 (second terminal 97, third terminal 98). Therefore, the length in the longitudinal direction at one end of the first terminal 96 (second terminal 97, third terminal 98) can be made relatively long. As a result, when one end of the first terminal 96 (second terminal 97, third terminal 98) is bent and deformed from the bent portion of the bent portion 96A (bent portion 97A, bent portion 98A) due to the change in the environmental temperature of the rotary electric machine 10, the stress generated in the bent portion can be dispersed. Therefore, it is possible to more effectively prevent or suppress the occurrence of cracks or the like in the soldered portion between the first to third terminals 96, 97, 98 and the second substrate portion 71B, and it is possible to effectively prevent or suppress the damage of the first to third terminals 96, 97, 98.

Further, an installation portion 61 is formed on the outer peripheral portion of the lower surface 60E of the heat sink 60, and the installation portion 61 is projected downward from the heat sink 60 and extends in the circumferential direction of the heat sink 60. The outer peripheral portion of the first substrate portion 71A of the circuit board 70 is installed in the installation portion 61. Further, a plurality of FETs 74 are mounted on the upper surface of the first substrate portion 71A, and the FETs 74 are arranged radially inside the installation portion 61 in a bottom view. Therefore, the installation portion 61 can form an arrangement structure that surrounds the FET 74. As a result, the installation portion 61 can prevent the heat-dissipating grease interposed between the FET 74 and the heat sink 60 from scattering from between the heat sink 60 and the circuit board 70 toward the motor portion 12. Further, as described above, since the installation portion is arranged so as to surround the FET 74, the installation portion 61 functions as a shield portion that shields electrical noise from the FET 74. Thereby, for example, radiation noise from the FET 74 can be reduced.

Further, a fitting groove 60K is formed on the upper surface of the heat sink 60 at the peripheral edge of the terminal insertion portion 60G, and a fitting rib 92A to be fitted into the fitting groove 60K is formed on the lower surface of the mold base 92 of the connector assembly 90. As a result, the fitting rib 92A and the fitting groove 60K can prevent the inner portion of the fitting rib 92A in the mold base 92 from being thermally deformed (thermal expansion or contraction) in the first direction and the second direction when the environmental temperature of the rotary electric machine 10 changes. Therefore, it is possible to prevent the base end portion of one end portion of the first to third terminals 98 embedded inside the fitting rib 92A in the mold base 92 from being displaced in the first direction and the second direction. Therefore, it is possible to suppress the action of stress on the soldered portion between the first to third terminals 98 and the second substrate portion 71B when the environmental temperature of the rotary electric machine 10 changes.

Further, in the connector assembly 90, two collars 95 corresponding to the first fixing screw portion 60C1 of the heat sink 60 are arranged between the fitting rib 92A and the first connector portion 93A, the second connector portion 93B, and the third connector portion 93C. As a result, when the external connector is inserted into the first connector portion 93A, the second connector portion 93B, and the third connector portion 93C, it is possible to prevent the first connector portion 93A, the second connector portion 93B, and the third connector portion 93C from being displaced upward, and it is also possible to suppress the upward displacement of one end portion of the first to third terminals 96, 97, 98 integrally formed with the mold portion 91. Thus, when the external connector is inserted into the first connector portion 93A, the second connector portion 93B, and the third connector portion 93C, it is possible to reduce the occurrence of excessive stress in the soldered portion between the first to third terminals 96, 97, 98 and the second substrate portion 71B.

Further, the bus bar 48 of the motor portion 12 and three connection terminals 86 press-fitted and fixed are provided on the first substrate portion 71A fixed to the heat sink 60. Therefore, when the bus bar 48 is press-fitted into the terminal connection portion 88 of the connection terminal 86, it is possible to prevent the first substrate portion 71A from bending (displacing) upward. As a result, the bus bar 48 can be satisfactorily press-fitted into the connection terminal 86. Therefore, workability when the bus bar 48 is press-fitted into the connection terminal 86 can be improved.

Further, the circuit board 70 (first substrate portion 71A) is fixed to the heat sink 60 at a position between the connection terminal 86 at the center of the second direction and the connection terminal 86 on the other side of the second direction. In other words, the fourth substrate fixing portion 63D of the heat sink 60 for fixing the first substrate portion 71A is arranged close to the connection terminal 86. Therefore, the upward press-fitting load acting on the first substrate portion 71A when the bus bar 48 is press-fitted into the terminal connection portion 88 of the connection terminal 86 can be received by the fourth substrate fixing portion 63D arranged close to the connection terminal 86. As a result, the bus bar 48 can be more satisfactorily press-fitted into the connection terminal 86, and the press-fitting load can be effectively distributed to the heat sink 60.

Further, as described above, the step portion 62 of the heat sink 60 is arranged so as to be separated from the second substrate portion 71B of the circuit board 70 on the upper side, and a gap G is formed between the step portion 62 and the second substrate portion 71B. Further, the tip portion at one end of the first to third terminals 96, 97, 98 is soldered to the second substrate portion 71B of the circuit board 70 and protrudes downward from the circuit board 70. The soldering state between the first to third terminals 96, 97, 98 and the second substrate portion 71B is configured to be visible from the gap G. Therefore, the soldered state between the first to third terminals 96, 97, 98 and the second substrate portion 71B can be confirmed not only from the side opposite to the step portion 62 of the circuit board 70 (i.e. the lower side), which is one end (tip) side of the first to third terminals 96, 97, 98, but also from the step portion 62 side (i.e. the upper side) of the circuit board 70. In other words, the soldering state of the first to third terminals 96, 97, 98 and the second substrate portion 71B can be confirmed from both sides of the circuit board 70 in the plate thickness direction. As a result, it is possible to confirm the sucked-up state of the solder for soldering the first to third terminals 96, 97, 98. Therefore, workability when assembling the connector assembly 90 to the heat sink 60 can be improved.

Further, in the rotary electric machine 10, the FET 74 of the circuit board 70 and the connector assembly 90 are arranged at positions where they do not overlap in a plan view. Therefore, the heat generated by the FET 74, which is a heat generating member, can be transferred to the heat sink 60, and the transferred heat can be efficiently dissipated to the outside of the rotary electric machine 10 by the heat sink 60.

Further, in the connector assembly 90, the fixing portion to the heat sink 60 is composed of a metal collar 95, and the connector assembly 90 is fastened and fixed to the heat sink 60 by the fixing screw SC3 inserted in the collar 95. As a result, the connector assembly 90 can be fastened and fixed to the heat sink 60 with the fixing screw SC3 and the collar 95 metal-touched. As a result, even if the environmental temperature of the rotary electric machine 10 changes, the fixed state of the connector assembly 90 and the heat sink 60 can be maintained satisfactorily.

In the present embodiment, the first terminal 96 (second terminal 97, third terminal 98) has two bent portions 96A (bent portion 97A, bent portion 98A), but the first terminal 96 (second terminal 97, third terminal 98) may have three or more bent portions 96A (bent portion 97A, bent portion 98A).

Further, although two bent portions 96A (bent portion 97A, bent portion 98A) formed in the first terminal 96 (second terminal 97, third terminal 98) are formed in a crank shape, and one end of the first terminal 96 (second terminal 97, third terminal 98) has a roughly U-shape open in a direction orthogonal to the extending direction in the present embodiment, the shape of the bent portion 96A (bent portion 97A, bent portion 98A) is not limited to this. For example, the bent portion 96A (bent portion 97A, bent portion 98A) may be formed so that one end of the first terminal 96 (second terminal 97, third terminal 98) has a zigzag shape. Further, the bent portion of the bent portion 96A (bent portion 97A, bent portion 98A) may be formed so as to bend in an arc shape.

Further, although the first connector portion 93A, the second connector portion 93B, and the third connector portion 93C of the connector assembly 90 are arranged on the radial outer side of the housing 20, and formed in a cylindrical shape that opens downward in the present embodiment, the positions of the first connector portion 93A, the second connector portion 93B, and the third connector portion 93C can be appropriately changed according to various steering devices. For example, the first connector portion 93A, the second connector portion 93B, and the third connector portion 93C may be projected upward from the mold base 92 to form a cylindrical shape open upward, and may be arranged at a position that overlaps with the housing 20 in a plan view. In this case, since the first connector portion 93A, the second connector portion 93B, and the third connector portion 93C are not arranged on the radial outer side of the housing 20, it can contribute to the miniaturization of the rotary electric machine 10 in the radial direction.

As the present embodiment has been described above, the reliability can be improved according to these embodiments.

### DESCRIPTION OF THE REFERENCE NUMERALS

10 Rotary electric machine, 12 Motor portion, 20 Housing, 48 Bus-bar, 60 Heat-sink, 60F1 First recess (displacement allowing portion), 60F2 Second recess (displacement allowing portion), 60G Terminal insertion portion (insertion portion), 62 Step portion (displacement allowing portion), 70 Circuit board (substrate), 71A First substrate portion, 71B Second substrate portion, 86 Connection terminal, 90 connector assembly, 91 Mold portion 96 First terminal (terminal), 96A Bent portion, 97 Second terminal (terminal), 97A Bent portion, 98 Third terminal (terminal), 98A Bent portion, G Gap

1. A rotary electric machine, comprising:
a motor portion with a bottomed cylindrical housing with one end closed in the axial direction;
a heat sink that closes an opening of the housing;
a connector assembly configured to include a mold portion fixed to the heat sink and a terminal integrally formed with the mold portion;
a substrate that is divided into a first substrate portion fixed to the heat sink and a second substrate portion to which the terminal is soldered, wherein the entire substrate overlaps the heat sink when viewed from the axial direction of the motor portion; and
a displacement allowing portion that constitutes a portion of the heat sink facing the second substrate portion, is arranged apart from the second substrate portion, and allows displacement of the second substrate portion in the plate thickness direction.

2. The rotary electric machine according to claim 1, wherein the terminal extends along the plate thickness direction of the substrate and includes a bent portion bent in a direction intersecting the extending direction.

3. The rotary electric machine according to claim 1, wherein the first substrate portion is provided with a connection terminal for being press-fitted and fixed to a bus bar of the motor portion.

4. The rotary electric machine according to claim 1 wherein:
an insertion portion through which one end of the terminal is inserted is formed in the displacement allowing portion;
one end of the terminal protrudes to the opposite side of the displacement allowing portion of the substrate; and
the solder connection portion between the terminal and the substrate is configured to be visible from a gap between the displacement allowing portion and the substrate.
